(19) United States
(12) Patent Application Publication
(10) Pub. No.: US 2024/0296309 A1
(43) Pub. Date: Sep. 5, 2024

(54) INCORPORATING STRUCTURED KNOWLEDGE IN NEURAL NETWORKS

(71) Applicant: Microsoft Technology Licensing, LLC, Redmond, WA (US)

(72) Inventors: Bhaskar MITRA, Montreal (CA); Yordan Kirilov Zaykov, Cambridge (GB); John Michael Winn, Redmond (GB); James John Hensman, Redmond (GB)

(21) Appl. No.: 18/141,141

(22) Filed: Apr. 28, 2023

Related U.S. Application Data
(60) Provisional application No. 63/449,713, filed on Mar. 3, 2023.

(51) Int. Cl. G06N 3/042; G06N 3/08

(52) U.S. Cl. CPC G06N 3/042; G06N 3/08

(57) ABSTRACT

An approach to structured knowledge modeling and the incorporation of learned knowledge in neural networks is disclosed. Knowledge is encoded in a knowledge base (KB) in a manner that is explicit and structured, such that it is human-interpretable, verifiable, and editable. Another neural network is able to read from and/or write to the knowledge model based on structured queries. The knowledge model has an interpretable property name-value structure, represented using property name embedding vectors and property value embedding vectors, such that an interpretable, structured query on the knowledge base may be formulated by a neural model in terms of tensor operations. The knowledge base admits gradient-based training or updates (of the knowledge base itself and/or a neural network(s) supported by the knowledge base), allowing knowledge or knowledge representations to be inferred from a training set using machine learning training methods.

### CROSS REFERENCE TO RELATED APPLICATIONS

This application claims the benefit of U.S. Provisional Application No. 63/449,713, filed Mar. 3, 2023, entitled “ATTENTION MECHANISMS IN NEURAL NETWORKS,” which is incorporated herein by reference in its entirety.

### TECHNICAL FIELD

The present disclosure pertains to the incorporation of structured knowledge in neural networks (e.g., using attention mechanisms), including systems, methods and computer programs for implementing the same.

### BACKGROUND

In recent years, a popular strategy in neural representation learning has emerged that involves training over-parameterized deep learning models (such as deep neural networks) on vast quantities of unlabeled data at scale. A neural network has a set of weights (potentially very large number of weights) that are tuned via a structured training method on a suitable training set. Such models, sometimes referred to as foundation models, have demonstrated breakthrough improvements in a myriad of downstream tasks spanning across different modalities such as image, audio and text.

Until recently, state of the art performance has been achieved in various applications with relatively mature neural network architectures, such as convolutional neural networks. However, newer architectures, such as “transformers”, are beginning to surpass the performance of more traditional architectures in a range of applications (such as computer vision and natural language processing). Encoder-decoder neural networks, such as transformers, have been developed based solely or primarily on “attention mechanisms”, removing or reducing the need for more complex convolutional and recurrent architectures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

An approach to structured knowledge modeling and the incorporation of learned knowledge in neural networks is disclosed. Knowledge is encoded in a knowledge base (KB) in a manner that is explicit and structured, such that it is human-interpretable, verifiable, and editable. Another neural network is able to read from and/or write to the knowledge model based on structured queries. For example, in the described implementation, a novel attention function allows a neural network to attend over the structured knowledge base or some part of the structured knowledge base (one example of a read mechanism). The knowledge model and attention function address practical issues that arise in state-of-the-art machine learning systems, particularly those which produce plausible but incorrect outputs. The knowledge model has an interpretable property name-value structure, represented using property name embedding vectors and property value embedding vectors, such that an interpretable, structured query on the knowledge base may be formulated by a neural model in terms of tensor operations. The knowledge base, therefore, admits gradient-based training or updates (of the knowledge base itself and/or a neural network(s) supported by the knowledge base), allowing knowledge or knowledge representations to be inferred at speed and at scale from a training set using machine learning training methods and, typically, accelerator hardware, such as graphical processing unit(s)), but does so without sacrificing interpretability of the knowledge base, and without sacrificing the ability to verify or correct the knowledge base. The present approach has numerous practical applications, including the processing of generation of images, videos, text, audio etc. Another application is cybersecurity, where cybersecurity knowledge may be captured in a structured model and used, e.g., to implement cyberthreat detection and/or cyberthreat remediation.

### BRIEF DESCRIPTION OF FIGURES

For a better understanding of the subject matter disclosed herein, embodiments will now be described by way of example only, with reference to the following figures, in which:

FIG. 1 shows a schematic overview of a knowledge base supporting a neural network;

FIG. 2 shows a schematic overview of a knowledge base supporting multiple neural networks;

FIG. 3 shows a portion of an example object-oriented knowledge base containing human-interpretable property names and property values;

FIG. 4 shows two example knowledge base entities associated with respective property name-value pairs;

FIG. 5 shows two example knowledge base entities having a parent-child relationship and associated with respective property name-value pairs;

FIG. 6 shows a schematic block diagram for an example neural network attention layer capable of querying a structured knowledge base;

FIG. 7 shows a breakdown of a first example attention function;

FIG. 8 shows a breakdown of a second example attention function;

FIG. 9 shows a schematic block diagram of an example joint training architecture for a neural network and a structured knowledge base;

FIG. 10 shows a schematic block diagram of example separated training architectures for a neural network and a structured knowledge base, respectively;

FIG. 11 shows a schematic overview of an example joined training methodology;

FIG. 12 shows a schematic flowchart for an example method of implementing an attention mechanism in a neural network; and

FIG. 13 shows a schematic block diagram of an example computer system.

### DETAILED DESCRIPTION OF EXAMPLE EMBODIMENTS

In the examples described herein, a neural attention mechanism is implemented using a novel form of structured query on a structured knowledge base (KB), in which entities are represented in terms of individual properties. Each property is characterized by a property name-value pair, for which property name and value embeddings are learned. The learned embeddings capture relationships between individual properties. This formulation admits gradient-based training/updating of the knowledge base through structured training methodologies (e.g., backpropagation and stochastic gradient descent/ascent). This approach retains the ability to learn knowledge by inference from a training set, but does so in a far more interpretable (and verifiable/correctable) manner, because the structure of the knowledge base means the tensor embeddings in the knowledge base (which may have been learned or partially learned from a training set) are far more interpretable than the learned weights in a conventional neural network. Moreover, by constructing the knowledge base and attention mechanism in a manner that admits gradient-based training but nevertheless retains an interpretable structure, the learning of knowledge can be performed at far greater speed and scale (e.g., through structured training on a graphical processing unit(s) or other accelerator hardware) compared with manual updates, without sacrificing interpretability, verifiability or correctability. Because entities are represented in terms of individual properties, once individual property embeddings have been learned, it is possible to modify the knowledge base (e.g., to add or modify properties of existing entities, add new entities etc.) without retraining. This stands in contrast to existing neural networks, such as foundation models, where knowledge is captured across the weights of the network, in a manner that is not interpretable, and requires retraining of the network to modify the implicit knowledge, which is both expensive and unpredictable in its outcome. The present approach also stands in contrast to approaches that attempt to incorporate knowledge graphs in neural networks based on entity embeddings. Such entity embeddings are less flexible, and in particular do not allow entities to be modified or added without retraining.

Successful applications of foundation models include predicting missing information (e.g., masked language modeling) and conditional generation (e.g., image generation). These foundation models—e.g., large language models (LLMs) for text-go beyond ‘surface form’ modeling (such as text modeling in case of LLMs) by also capturing in its learned parameters some knowledge of entities and their properties that are described in training data used to train them.

However, existing foundation models are optimized to generate outputs (e.g., text, audio, image etc.) from the same distribution as the training data and not to accurately model knowledge, and hence often produce plausible but incorrect responses (e.g., factually incorrect text, unrealistic images etc.). There are several additional problems in casting LLMs as knowledge models. The representation of knowledge is latent in the model parameters, which makes it difficult to verify and correct them, as well as to track their provenance. Tracking provenance is not just important to build user trust in the system in the context of information access, but is also critical for compliance (e.g., to honor a right to be forgotten) and security reasons (e.g., to enforce user-specific information access controls). Finally, to incorporate fresh and updated knowledge, these very large models need to be retrained, which typically involves huge data and computational costs. To address some of these challenges, existing approaches involve augmenting these models with external sources of knowledge (e.g., retrieval augmented LLMs). However, in this case the flow of information is unidirectional from the external knowledge source into the model, which is useful if the goal is to make the LLM “less wrong” but falls short of a principled approach for knowledge modeling itself.

In the example embodiments described herein, a KB is provided in the form of a foundation model of structured knowledge. The KB can be combined with other foundation models (e.g., for text, image, audio etc.) such that the knowledge learnt during training of the KB is represented in an explicit form that is amenable to manual verification and curation.

Various example tasks that incorporate the KB are considered, both as training objectives and applications.

One task considered herein is joint masked modeling of neural network inputs (e.g., text, image, audio etc.). and elements of a structured KB. Joint masked modeling is a useful task that generalizes other existing tasks (e.g., semantic parsing of text to structured data, KB-conditioned text generation, KB completion, missing token prediction for text) in a single framework. Connections with recent developments in diffusion models are considered.

Another task is entity linking. In the context of an entity linking task, the ability of the knowledge model to learn cooccurrences/relationships between entity properties that may be useful for linking is useful.

In some examples, a neural network (e.g., another foundation model) interacts with the KB via a structured “attention mechanism” over entities contained in the KB. The structured attention mechanism is described in detail below. Among other things, this novel attention mechanism for neural networks facilitates improved knowledge modeling, thus addressing one or more of the practical issues with existing foundation models noted above.

Attention-based neural networks are increasingly important in the field of machine learning (ML). Attention mechanisms were historically used in ‘sequence2sequence’ networks (such as Recurrent Neural Networks). Such networks receive sequenced inputs and process those inputs sequentially. Historically, such networks were mainly used in natural language processing (NLP), such as text processing or text generation. Attention mechanisms were developed to address the ‘forgetfulness’ problem in such networks (the tendency of such network to forget relevant context from earlier parts of a sequence as the sequence is processed; as a consequence, in a situation where an earlier part of the sequence is relevant to a later part, the performance of such networks tends to worsen as the distance between the earlier part and the later part increases).

More recently, encoder-decoder neural networks, such as transformers, have been developed based solely or primarily on attention mechanisms, removing or reducing the need for more complex convolutional and recurrent architectures. Vaswani et al., “Attention Is All You Need” (2017), arXiv:1706.03762, introduced the transformer architecture and demonstrated state-of-the-art performance on the WMT 2014 English-to-German translation task. Transformers based solely on attention have been demonstrated to be highly effective on various natural language processing (NLP) tasks.

However, the efficacy of attention mechanisms is not limited to NLP. For example, in computer vision, state-of-the-art performance on many image processing tasks (e.g., classification, object detection, image segmentation, image generation etc.) has been achieved using convolutional neural networks trained on large datasets. However, recently, the efficacy of transformer networks on image processing tasks has also been demonstrated, and transformers have the potential to surpass CNNs over a wide range of computer vision tasks, in terms of both performance and efficiency.

Other viable technical applications of attention-based neural networks include image generation, audio signal processing, audio or music generation etc.

A transformer network receives an input sequence comprising multiple ‘tokens’ at respective sequence positions. Rather than processing the input sequence sequentially in the manner of the RNN, the transformer uses positional encodings (vector representations of the tokens' relative positions in the sequence) to encode the sequence positions, together with vector embeddings of the tokens themselves. In this context, attention mechanisms have been used as a way to capture relevance of one token to another token without relying on sequential processing.

A traditional neural attention function (e.g., as used in existing transformer networks) is applied to a query vector q and a set of key-value pairs. Each key-value pair is formed of a key vector kᵢ and a value vector vᵢ, and the set of key-value pairs is denoted {kᵢ, vᵢ}. An attention score for the ith key-value pair with respect to the query vector q is computed as a softmax of a dot product of the query vector with the ith key value, q·kᵢ. An output is computed as a weighted sum of the value vectors, {vᵢ}, weighted by the attention scores.

For example, in a self-attention attention layer of a transformer, query, key and value vectors are all derived from an input sequence (inputted to a self-attention layer) through matrix multiplication. The input sequence comprises multiple input vectors at respective sequence positions, and may be an input to the transformer (e.g., tokenized and embedded text, image, audio etc.) or a ‘hidden’ input from another layer in the transformer. For each input vector xⱼ in the input sequence, a query vector qⱼ, a key vector kⱼ and a value vector vⱼ are computed through matrix multiplication of the input vector xⱼ with learnable matrices W^{Q}, W^{V}, W^{K}. An attention score α_{i,j} for every input vector xᵢ with respect to position j (including i=j) is given by the softmax of qⱼ·kᵢ. An output vector yⱼ for token j is computed as a weighted sum of the values v₁, v₂, . . . , weighted by their attention scores: yⱼ=Σᵢα_{i,j}vᵢ. The attention score α_{i,j} captures the relevance (or relative importance) of input vector xⱼ to input vector xᵢ. Whilst the preceding example considers self-attention, similar mechanisms can be used to implement other attention mechanisms in neural networks, such as cross-attention.

The ‘query-key-value’ terminology reflects parallels with a data retrieval mechanism, in which a query is matched with a key to return a corresponding value. As noted above, in traditional neural attention, the query is represented by a single embedding vector q. In this context, an attention layer is, in effect, querying knowledge that is captured implicitly (in a non-interpretable, non-verifiable and non-correctable manner) in the weights of the neural network itself.

In the examples described herein, a neural attention mechanism is implemented using a different form of query on a structured KB, in which entities are represented in terms of individual properties. Each property is characterized by a property name-value pair (where the name acts as a key). One form of knowledge base described herein is structured as a collection of property name-value pairs, and a set of mappings between the property name-values pairs and a set of entities to which they pertain. The property name-values pairs and mappings are encoded as numerical embedding vectors (referred to as ‘embeddings’ for conciseness), meaning that a query on the knowledge base can be formulated in terms of tensor operations such as matrix multiplication. This formulation admits gradient-based training/updating of the knowledge base (e.g., to learn structured knowledge and/or structured knowledge representations) through structured training methodologies (e.g., backpropagation and stochastic gradient descent/ascent). This approach retains the ability to learn knowledge by inference from a training set, but does so in a far more interpretable (and verifiable/correctable manner), because the structure of the knowledge base means the tensor embeddings in the knowledge base (which may have been learned or partially learned from a training set) are far more interpretable than the learned weights in a conventional neural network. By improving the ability of a computer system to learn and/or incorporate knowledge through ML techniques, the functioning of the computer system is improved because it is able carry out machine learning tasks (supported by the knowledge base) with greater accuracy. Moreover, by constructing the knowledge base and attention mechanism in a manner that admits gradient-based training but retains an interpretable structure, the learning of knowledge can be performed at far greater speed and scale (e.g., through structured training on a graphical processing unit(s) or other accelerator hardware) compared with manual updates, without sacrificing interpretability, verifiability or correctability. Another benefit is the ability to use a learned or partially-learned knowledge base with different models and/or applications.

An embedding vector is a continuous numerical vector representation of some element. For example, KB properties and KB entities may each be represented by continuous numerically-valued embedding vectors in a d-dimensional embedding space. When embeddings are learned using structured training methods, semantic relationships between the property names or property values they represent are typically found to be captured in geometric relationships between the embedding vectors in the d-dimensional embedding space. For example, depending on how the KB is trained, semantically similar property names or property values might be assigned embedding vectors having a relatively high cosine similarity in the d-dimensional embedding space, or semantic relationship between property names or property values might be captured in terms of vector relationships between their respective embedding vectors.

In one or more examples herein, at least one first tensor is received at an attention layer of a neural network. Based on the at least one first tensor and at least one query generator parameter of the attention layer, the attention layer generates a structured query containing one or more query tensors. For example, the query tensors may comprise a match property name tensor and a match property value tensor defining one or more property name-value pairs that serve as matching conditions. Other examples of query tensors containing query parameters are described later. The attention layer of the neural network transforms the query tensor(s) based on one or more KB tensors representing the contents of the knowledge base. For example, the KB tensors may comprise a knowledge base name tensor comprising a plurality of numerical name vectors representing property names contained in the knowledge base and a knowledge base value tensor containing a plurality of numerical value vectors representing property values associated with the property names in the knowledge database. In the examples below, this transformation is performed by evaluating a defined attention function of the query tensors and the knowledge base tensors, resulting in a target output value vector. The attention function is evaluated to transform the first tensor(s) by applying one or more tensor operations to the query tensors and knowledge base tensors, where those tensor operations are analogous to ‘soft’ query operations on the knowledge base.

Aspects of the disclosure improve the functioning of a computing device implementing the knowledge base and/or neural network (or part(s) thereof) at least by representing the property names and/or property values of the knowledge base as tensors (that is, numerical tensor embeddings), enabling the knowledge base to be learned or updated through structured, gradient-based tuning of the query name tensor and the query value tensor, but doing so in a structured manner so that interpretability of the knowledge base is not sacrificed. Such gradient-based methods can be implemented highly efficiently using modern techniques and hardware (such as graphical processing unit(s) or other hardware accelerator processor(s)), at much greater speed and scale than would be required to build a comparable structured knowledge base using existing techniques. Alternatively or additionally, the structured training may involve learning a numerical representation of the KB (in terms of numerical embedding vectors) that are optimized for neural network processing. The ability of the system to learn knowledge or a knowledge representation is also improved through the ability to construct and train (or partially train) a knowledge base in this manner, yielding a consequent improvement in the performance of the neural network supported by the knowledge base. The ability to maintain a structured, interpretable knowledge database (compared with unstructured knowledge sources, such as implicit knowledge distributed across the weights of a large, deep neural network in a manner that is very hard to interpret) means the knowledge base can be updated or modified to incorporate knowledge from other source(s) much more efficiently and reliably (compared with, e.g., retraining or re-architecting a deep neural network to address identified errors in its implicit knowledge, which not only requires significant development and computational resources, but is also not guaranteed to address the identified issues and may result in new, unanticipated issues). Moreover, errors in the present structured knowledge base can be identified far more easily and efficiently (compared with, say, a deep neural network, where extensive data-driven validation may be required to infer such errors from erroneous outputs, again requiring significant development and computational resources; indeed, errors in a deep network's implicit knowledge may only come to light once the network has already been deployed, which could have catastrophic consequences in worst-case scenarios, e.g., in applications such as autonomous driving where performance is safety-critical).

A machine learning architecture incorporating the attention mechanism is described, which has a separation of responsibilities between modeling language and modeling knowledge, while leveraging recent advances in deep learning for both. The architecture may be referred to herein as a structured KB attention architecture. A neural knowledge model is combined with a second neural model (such as a language model, computer vision model, audio model or other ‘foundation’ model) such that there is both a clear separation of modeling responsibilities and bidirectional flow of information between the two models.

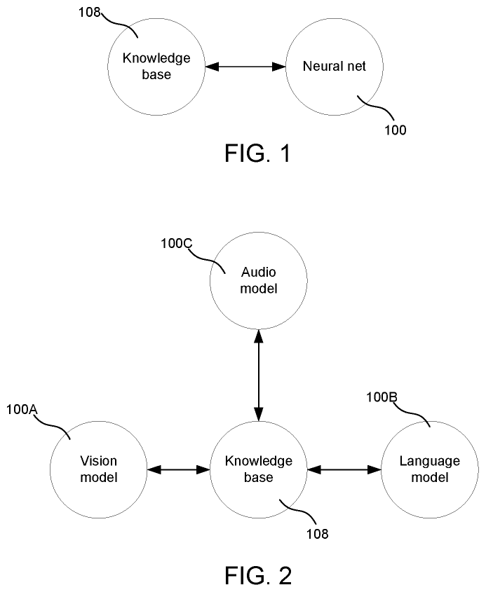

FIG. 1 shows a highly schematic block diagram of a neural model, in the form of a neural network 100, supported by a knowledge model in the form of structured knowledge base 108.

The architecture can also be extended to incorporate multiple foundation models for other modalities to the same knowledge model.

FIG. 2 shows a highly schematic block diagram of the knowledge base 108 supporting a plurality of neural networks, including a computer vision model 100A, a language model (e.g., LLM) 100B and an audio model 100C.

The knowledge base 108 encodes knowledge in a manner that is explicit and structured, such that it is human-interpretable, verifiable, and editable.

Other neural models, such as the computer vision model 100A, the language model 100B and/or the audio model 100C, are able to both read from and write to this knowledge base 108.

The knowledge base 108 may be written to during training and/or at runtime (inference) after it has been trained. In training, a representation layer of the knowledge base 108 is learned that allows both reading from and writing to the knowledge base 108.

For example, a joint masked modeling task is considered, in which the neural network 100 is trained to predict missing values in the knowledge base 108 based on some input data (such as text) and/or vice versa. Once trained in this manner, the model 100 may be used for inference on a piece of input data (e.g., text) to extract corresponding KB values (which may, for example, then be written to the KB 108 for later use) and/or use the KB 108 to populate missing tokens in the input data (reading from the KB 108 to complete the input data).

The knowledge base 108 handles heterogenous properties, such as strings, dates, quantities or other human-interpretable property names or values. In addition to their human-interpretable representation, these are also represented as d-dimensional embedding vectors, allowing the neural network 100 to interface with the knowledge base 108 (and learn how to do so effectively during training).

The knowledge base 108 models relationships between entities and properties (it may, for example, have the ability to recognize that the graduation date for a person always comes later than their date of birth) and has predictive capabilities (e.g., the ability to predict missing properties and/or how property values change over time in the context of a given KB). This property distinguishes the present knowledge base 108 from traditional knowledge bases; the latter is focused solely on storing rich entity/property information while the former is focused on modeling it. This can be seen as analogous to the distinction between an LLM and the actual text.

There are different ways that the knowledge base 108 may be instantiated.

In the following examples, the knowledge base 108 does not represent entities explicitly, but rather represents each entity as a collection of properties (property name-value pairs). To interface with the neural network 100, embeddings of the KB properties are learned, meaning each entity is represented as a collection of property name embedding vectors and associated property value embedding vectors (as opposed to entity embedding vectors). In the following examples, an entity is represented solely in terms of its properties. Hence, to read or write information about some target entity to/from the knowledge base 108, the neural network 100 generates a structured query formulated in terms of properties of the entity. The following examples consider an illustrative object-oriented view. However, the teaching can be extended to other forms of knowledge bases to represent entities contained in the knowledge base in terms of their property embeddings.

An alternative would be to learn a single entity embedding for each entity of interest (such as an embedding of an entity node in a knowledge graph), representing each entity as whole, rather than in terms of its individual properties. However, this entity-embedding approach is less flexible than the property-embedding approach described herein. For example, in the present property-embedding approach, new entities can be added to the KB 108 after it has been trained, and without further training, even if those entities were not encountered during training of the KB 108. This is possible because new entities can be added and represented in terms of new property combinations that were not necessarily encountered in training.

In the described approach, rather than learning entity representations, the focus is modeling correlations between properties.

One use case for a KB property-embedding representation is cybersecurity, where a KB may be trained on data relating to a particular set of entities (such as users, devices, systems, applications, processes etc.) but then applied, once trained, to a different set of entities (which, in practice, may be changing over time, e.g., as users, devices, systems, applications, processes etc. are added). For example, in a cloud security context, a knowledge base trained on, say, one enterprise user can be applied to a different enterprise user even if they have no overlap in their associated entities.

The described property representation learning also supports ways to construct new KBs from other sources such as text data.

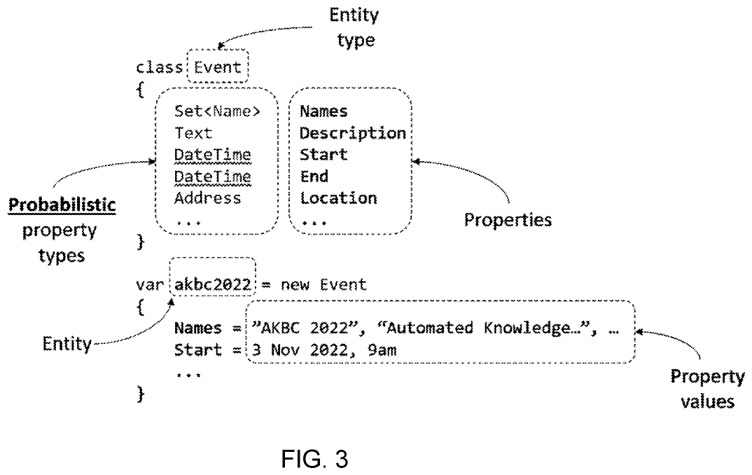

FIG. 3 schematically depicts, by way of example, an object-oriented view of a knowledge base, in which entities are represented as objects, which are instances of an object class (where each object class corresponds to an entity type). An object class is defined with an entity property or properties, and each instance of that class (object) assigns property value(s) to the property (or properties). Whilst an object-oriented view of the knowledge base 108 is considered, the described ML architecture is not limited in this respect, and the knowledge base 108 may be implemented in other ways.

Building on the object-oriented view, in one implementation, an entity is described as a ‘bag’ of property name-value pairs (where each name acts as a key). A property name-value pair may be referred to as a property for conciseness. The entity type in this context can also be represented as a type property of the entity.

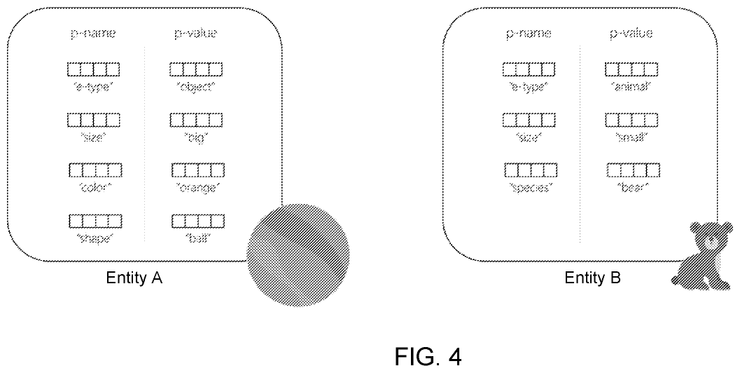

FIG. 4 shows a simple illustration of two example entities (Entity A and Entity B), each of which is represented as a bag of property name-value pairs.

To allow for gradient-based updates to this knowledge representation, each property name and each property value is further represented as a d-dimensional numerical embedding vector. With n entities and a total of m property name and value pairs (that is, m name-value pairs), across these n entities then, this example KB may be represented using KB tensors defined as follows.

A knowledge base property name (KBPN) tensor Iₚₙ∈ [symbol] ^{m×d} containing m embedding vectors of dimension d corresponding to m property names.

A knowledge base property value (KBPV) tensor Iₚᵥ∈ [symbol] ^{m×d} containing m embedding vectors of dimension d corresponding to m property values respectively associated with the m property names.

An entity-property (EP) mapping tensor Iₑₚ∈{0,1}^{n×m}, which is a binary tensor mapping each of the n entities to each of the respective properties that belong to that entity.

A property name-value pair contained in the knowledge base 108 may be referred to as a knowledge base property (KBP). An ith KBP is thus represented by the ith row of the KBPN tensor Iₚₙ (the d-dimensional name embedding of which acts as a key) and the ith row of the KBPV tensor Iₚᵥ (the d-dimensional value embedding), denoted by ((Iₚₙ)ᵢ, (Iₚᵥ)ᵢ) where (Iₚₙ)ᵢ=((Iₚₙ)_{i,1}, . . . , (Iₚₙ)_{i,n}) is the ith row of Iₚₙ and (Iₚᵥ)ᵢ=((Iₚᵥ), . . . , (Iₚᵥ)_{i,n}) is the ith row of Iₚᵥ.

KPS are mapped to entities in the following manner. If the jth row of the EP mapping tensor Iₑₚ contains a one in column i (that is, (Iₑₚ)_{j,i}=1), this implies the ith name-value pair ((Iₚₙ)ᵢ, (Iₚᵥ)ᵢ) is associated with the jth entity. If all positions in row j (that is, (Iₑₚ)_{j,k}=0 ∀k≠j), this implies the ith name-value pair ((Iₚₙ)ᵢ, (Iₚᵥ)ᵢ) is associated with only the jth entity

As well as mapping of KBPs to entities, relationships between entities are considered.

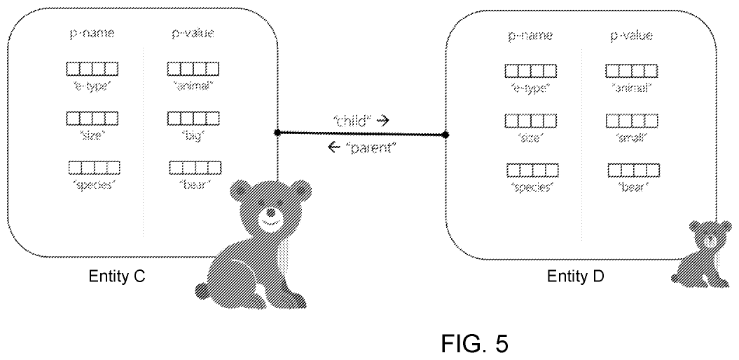

FIG. 5 shows an example of two entities (Entity C and Entity D) within the knowledge base 108 having a parent-child relationship. Relationships between entities can be further conceptualized as directed edges between entities, represented in tensor notation as an entity-entity (EE) relationship tensor Iₑₑ∈ [symbol] ^{n×n×d} where the relationship between every pair of entities is summarized by a d-dimensional embedding vector.

A structured attention mechanism over KB entities will now be described.

Consider a scenario where, conditioned on some latent vector (e.g., an embedding of a text token), it is desirable to attend over the KB 108. While traditional neural attention mimics the vector space model of retrieval, in this example scenario, a structured attention mechanism is defined over a knowledge base that is more analogous to a “soft” SQL query. In traditional neural attention, the “query” is represented by a single embedding vector. In the present example, a structured query is represented by a model-generated set of query tensors (generated by the neural network 100) conditioned on, e.g., the text token. The following considers a set of query tensors comprising a 1×k match-property-importance (MPI) tensor, a k×d match property name (MPN) tensor, a k×d match-property-value (MPV) tensor and a 1×d target property name (TPN) tensor:

[symbol]

Qₘₚᵢ∈ [symbol] ^{1×k},Qₘₚₙ∈ [symbol] ^{k×d},Qₘₚᵥ∈ [symbol] ^{k×d},Qₜₚₙ∈ [symbol] ^{1×d} [symbol] ,

in which Qₘₚᵢ is the MPI tensor, Qₘₚₙ is the MPN tensor, Qₘₚᵥ is the MPV tensor and Qₜₚₙ is the TPN tensor.

To interpret the query tensors, it is useful to consider a concrete example. Take the SQL query: SELECT color WHERE size==“big” AND shape==“ball”. This defines some target entity in terms of its properties (size and colour). A “softer” version of this query involves matching k (e.g., k=2 in this case) different conditions where for each condition both property name and value need to be matched. In this example, the MPN tensor Qₘₚₙ contains k embedding vectors corresponding to k match property names, e.g. “size” and shape” (denoted E_{size} and Eₛₕₐₚₑ respectively), involved in the matching. Consequently, the MPV tensor Qₘₚᵥ contains k embedding vectors corresponding to k match property values, such as “big” and “ball” (denoted E_{big} and E_{ball} respectively, where “big” is a value of the “size” property and “ball” is a value of the “shape” property). While in a conventional SQL query these conditions are enforced as an exact match, in this example the specified k match property name(s) and k match property value(s) instead produce real valued matching scores. Therefore, these conditions may also be weighted by relative importance which is captured by the MPI tensor Qₘₚᵢ. Finally, the TPN tensor Qₜₚₙ stores the embedding vector for a target property name to be extracted, such as “color”:

$${Q}_{mpi} = [ 1 , 1 ] , {Q}_{mpn} = [ {E}_{size} , {E}_{shape} ] , {Q}_{mpv} = [ {E}_{big} , {E}_{ball} ] , {Q}_{tpn} = {E}_{color} ,$$

As explained below, Qₘₚₙ and Qₘₚᵥ are interpreted as defining k match properties as property key-values pairs, which are (E_{size}, E_{big}) and (Eₛₕₐₚₑ, E_{color}) in the above example.

More generally, an ith match property (MP) is defined as a property key-value pair comprising the ith match property name embedding vector of Qₘₚₙ and the ith match property value embedding vector of Qₘₚₙ, denoted as ((Qₘₚₙ)ᵢ, (Qₘₚᵥ)ᵢ). Given the above query representation, an attention function over the KB 108 may be defined. The attention function is a function of the query tensors Qₘₚᵢ, Qₘₚₙ, Qₘₚᵥ and Qₜₚₙ and the KB tensors Iₚₙ, Iₚᵥ and Iₑₚ, which returns a target property value tensor, oₚᵥ The following example considers an attention function comprising a matching term and an extraction term, which returns a 1×k target property value as follows (Equation 1):

$${O}_{pv} = Φ ( {Q}_{mpi} \times ( Ω ( {Q}_{mpn} \times {I}_{pn}^{T} ) ⊙ ( {Q}_{mpv} \times {I}_{pv}^{T} ) ) \times {I}_{ep}^{T} ) \times ( {I}_{ep} \times ( Ω ( {I}_{pn} \times {Q}_{tpn}^{T} ) ⊙ {I}_{pv} ) ) ,$$

where, ⊙ is Hadamard product, x is matrix multiplication (or, more generally, tensor multiplication), τ denotes matrix transpose, Ω is element-wise sigmoid, and Φ is softmax along a final tensor dimension. In this example, this structured attention function first computes a probability distribution over entities and then aggregates the target property value across all entities weighted by that distribution (which results in the target property value tensor in this example).

Property names, values, mappings between entities and properties and relationships between entities are all represented numerically as tensors in the manner described above (property names, values and entity relationships using embedding vectors, and property-entity mappings with binary vectors). This numerical representation, in turn, allows SQL-like query elements to be represented in terms of tensor operations (matrix multiplication, the Hadamard product, and softmax and sigmoid normalization in the above examples). The tensor operation-based attention is different than a traditional SQL query in that it's not performing an exact match but a softer/fuzzy matching. SQL is a declarative query language based on first-order logic. The same principles can be extended to other forms of query language. More generally, with the embedding-based representation of the KB, it is possible to represent various query operations or logic predicates in terms of tensor operations on the numerical embeddings, and perform soft matching using those tensor operations.

The operation of the attention function may, therefore, be summarized as follows:
1) The soft structured query comprises the following elements, all represented as numerical tensors:
   a) A set of k matching conditions, where each matching condition is described by embeddings of a match property (a match property name paired with a match property value embeddings).
   b) Relative importance of the k conditions.
   c) A target property to be retrieved from matching entities, which is described by a target property name embedding.
2) The attention function then performs the following:
   a) For each entity in the KB compute a property match score by comparing each of the k conditions in the query with each of the properties of the entity and aggregate the property match scores.
   b) Compute a probability distribution over the entities as a function of their match scores from step 2a.
   c) For each entity compute a similarity between each of its property name embeddings and the target property name embedding in the query.
   d) For each entity, compute a probability distribution over its properties as a function of its match scores from step 2c.
   e) Aggregate all property values across all entities in the KB based on the two probability distributions from 2b and 2d.

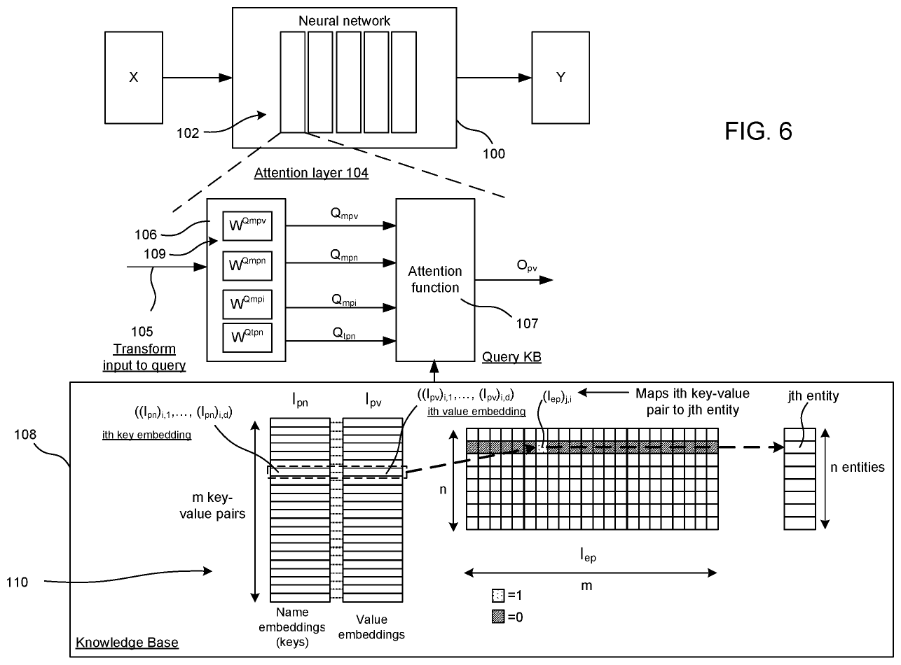

FIG. 6 depicts a system comprising the neural network (NN) 100 and the knowledge base 108 in further detail. The KB tensors of the KB 108 are denoted by reference sign 110. The NN 100 is configured to receive an input tensor X and generate an output tensor Y. The NN 100 is shown to comprise a plurality of neural network layers 102, at least one of which is an attention layer 104.

The attention layer 104 is shown to comprise an input transformation sub-layer 106 and a query sub-layer 107. The input transformation sub-layer is shown receiving a first tensor 105, which may for example be the input tensor X, a ‘hidden’ tensor generated by another of the layers 102, or an earlier output of the neural network 100 (e.g., in some architectures, a previous output of the network is fed-back as an input). The transformation sub-layer 106 is parameterized by one or more query generators 109, which are tensors (specifically, matrices) in this example. In this example, four query generators are considered: an MPV query generator W^{Q}^{ₘₚᵥ}, an MPN query generator W^{Q}^{ₘₚₙ}, an MPI query generator W^{Q}^{ₘₚᵢ} and a TPN query generator W^{Q}^{ₜₚₙ}, which are tensors in this example.

The first tensor 105 may, for example, be a token or token sequence. The first tensor 105 is transformed into a structured query comprising the above query tensors Qₘₚᵥ, Qₘₚₙ, Qₘₚᵢ, Qₜₚₙ by matrix multiplication with the query generators W^{Q}^{ₘₚᵥ}, W^{Q}^{ₘₚₙ}, W^{Q}^{ₘₚᵢ}, W^{Q}^{ₜₚₙ} respectively (so, Qₘₚᵥ is computed by matrix multiplication of the first tensor 105 with the MPN query generator W^{Q}^{ₘₚᵥ} etc.). Hence, in learning the query generators Qₘₚᵥ, Qₘₚₙ, Qₘₚᵢ, Qₜₚₙ, the neural network 100 learns how to generate an appropriate query from a given input tensor 105.

So, for example, when performing cross-attention between text (or some other input modality) and the KB 108, then conditioned on a token embedding on the text side, it is possible to attend over the KB 108. Here, the different components of the structured query will be generated by matrix multiplication over a token embedding.

Note that the term ‘token’ can refer to any atomic element, and the terminology does not necessarily imply an NLP application. In an NLP context, a token may for example be a word or phrase, or some transformation thereof, where a section of text is represented as a sequence of such tokens. In a vision application, a token may for example be a sequence of pixels or other image regions (e.g., an image might be represented a as sequence of pixel or region tokens) or a whole image (e.g., a video might be represented as a sequence of image tokens). A token could also be an audio or music datum where an audio signal or a piece of music is represented as a sequence of such tokens, or a piece of cybersecurity data. This applies more generally to other applications, including the additional applications described below. A ‘token’ can refer to the input X or the output Y, but also to the output of any internal (hidden) layer of the neural network. In is broadest sense, a token means some atomic element of data or information (e.g., within a sequence of such tokens). In the present context, tokens are represented by numerical embedding vectors.

The ML architecture described herein, and the KB-based attention mechanism in particular, has many practical applications in various fields of technology. In broad terms, the neural network 100 could for example be configured as a declarative network, used for, say, classification or regression tasks (a declarative network, broadly speaking, learns to generate predictions on previously unseen data) or a generative network (which, broadly speaking, has the ability to generate new datapoints). Applications of the neural network 100 include image classification or extracting information from images (e.g. classifying images, image regions, or image pixels; locating objects in images, e.g. by predicting object bounding boxes etc.), text classification, the extraction of structured or semi-structured information from text, audio signal classification (e.g. classifying different parts of an audio signal, e.g. in the context of voice recognition, to separate speech from non-speech, or to convert speech to text), extracting information from sensor signals, e.g. performing measurements using a classification or regression network operating on signals from one or more sensors, for example in a machine control application (e.g. such measurements may be used to measure physical characteristics of or relevant to a machine or system such as a vehicle, robot, manufacturing system, energy production system etc.), or in a medical sensing application such as patient monitoring or diagnostics (e.g. to monitor and classify a patient's vitals). Other applications include generating images (e.g. based on a text or non-text input), text (e.g. translating text from one language to another, or generating a response to a user's text input), audio data (e.g. synthetic speech, music or other sounds) or music (e.g. in digital or symbolic music notation), computer code that may be executed on a processor (e.g. computer code to control or implement a technical process on a computer or machine, e.g. generating code in response to a user's instructions express in natural language, translating or compiling code, such as source code, object code or machine code, from one programming language to another), modeling or simulation of physical, chemical and other technical systems, or discovering new chemical components or new uses thereof (including ‘drug discovery’ applications, to discover new therapeutic compounds or medicines, or new therapeutic uses). Any of the aforementioned applications, among others, may be improved in terms of performance (e.g., accuracy, precision, robustness/reliability) when supported by the structured knowledge base 108 (which, as noted, may be learned and shared across multiple applications/modalities). The system also has applications in cybersecurity. For example, a cybersecurity-specific knowledge base may be constructed using the described methods, to support a neural network carrying out a cybersecurity function, such as identifying anomalous or potentially suspicious data points or signals in cybersecurity data (which may, for example, embody cybersecurity telemetry collected using endpoint software and/or network monitoring component(s) etc.), or patterns indicative of potentially suspicious activity or behavior, so that an appropriate reporting, remediation or other cybersecurity action may be taken (e.g. generating an alert, terminating or quarantining an application, service or process, revoking user or application privileges etc.) based on an output of the neural network supported by the knowledge base (e.g. a detection output indicating potentially suspicious activity/behavior that has been detected, or another form of cybersecurity detection outcome). A generative cybersecurity model supported by a knowledge base may, for example, be configured to generate ‘synthetic’ cybersecurity data e.g., for the purpose of training, testing or validating other cybersecurity component(s) and model(s).

The query tensors [symbol] Qₘₚᵢ=[1,1], Qₘₚₙ=[E_{size}, Eₛₕₐₚₑ], Qₘₚᵥ=[E_{big}, E_{ball}], Qₜₚₙ=E_{color} [symbol] are generated via a matrix multiplication of the first tensor 105 with each of the four query generators W^{Q}^{ₘₚᵥ}, W^{Q}^{ₘₚₙ}, W^{Q}^{ₘₚᵢ}, W^{Q}^{ₜₚₙ}. Whilst in this example, each query tensor is generated from the same first tensor 105, in other implementations the query tensors may be generated from multiple tensors. The query generators W^{Q}^{ₘₚᵥ}, W^{Q}^{ₘₚₙ}, W^{Q}^{ₘₚᵢ}, W^{Q}^{ₜₚₙ} are tunable parameters of the neural network 100 that can be learned via gradient-based training (see FIG. 2). Whilst this example considers linear transformations of the first tensor 105, other forms of transformation (e.g., non-linear) may be used to generate the query tensors. The attention layer 106 learns to generate appropriate query tensors from a given first sensor 105 during training, through appropriate tuning of the query generators W^{Q}^{ₘₚᵥ} W^{Q}^{ₘₚₙ}, W^{Q}^{ₘₚᵢ}, W^{Q}^{ₜₚₙ}.

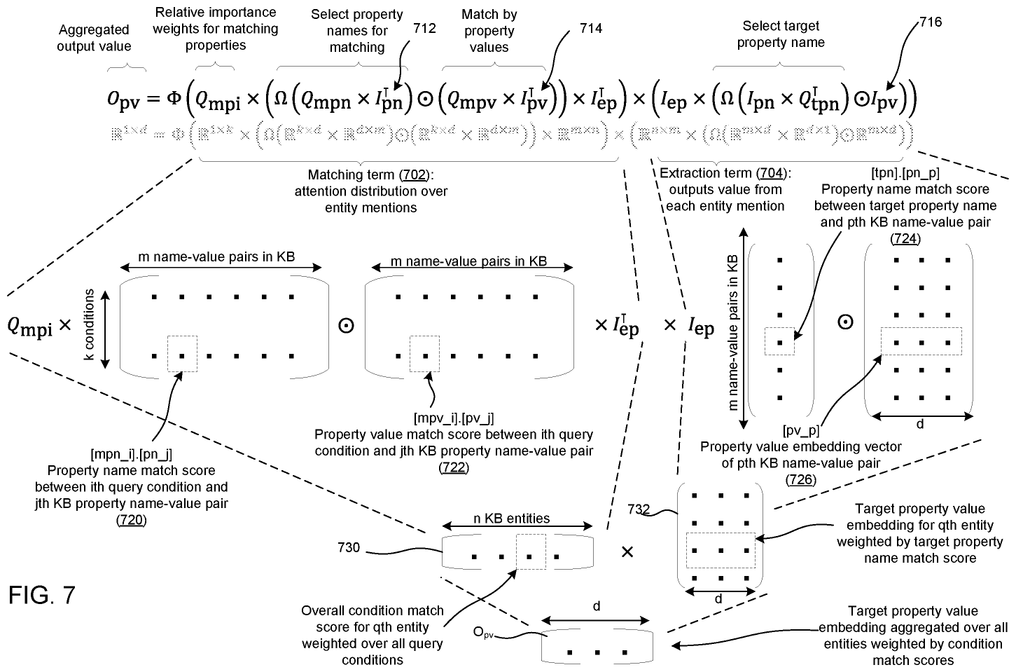

FIG. 7 shows an annotated and expanded version of Equation 1, which explains the role of various terms in Equation 1 in carrying out the aforementioned soft query.

Expanding on the above summary, in Equation 1, Φ(Qₘₚᵢ×(Ω(Qₘₚₙ×Iₚₙ^{τ})⊙(Qₘₚᵥ×Iₚᵥ^{τ}))×Iₑₚ^{τ}) is the matching term, denote by reference sign 702, which implements an attention distribution over entity mentions as follows. The matching term 702 compares the match property or properties defined in the structured query with the knowledge base, and quantifies their extent of similarity in terms of matching scores.

The matching term 702 comprises a match property name term and a match property value term, explained below.

In Equation 1, the matrix Ω(Qₘₚₙ×Iₚₙ^{τ}) is the match property name term, which computes a property name match score between each of the k match property name(s) specified in the MPN query tensor Qₘₚₙ and each of the m property names contained in the knowledge base 108. The MPN query tensor Qₘₚₙ selects the k match property name(s), where those k match property names are encoded in the mpn query tensor Qₘₚₙ as corresponding d-dimensional numerical property name embedding vectors. The matrix multiplication Qₘₚₙ×Iₚₙ^{τ} results in a k×m dimensional matrix, which is then normalized by the element-wise sigmoid operation.

In FIG. 7, reference numeral 720 denotes component i, j of the matrix Ω(Qₘₚₙ×Iₚₙ^{τ}) which contains the property name match score between the ith query condition and the jth knowledge base property. The first property name match score is given by the vector dot product between the embedding vector representing the ith match property name, [mpn_i](contained in the ith row of Qₘₚₙ), and the embedding vector representing the jth knowledge base property name, [pn_j] (contained in the jth column of Iₚₙ^{τ}). Because the match property name term is normalized in this example, the (i,j)th property name match score can be interpreted as a probability that the ith match property name of the mpn query tensor Qₘₚₙ matches the jth property name in the knowledge base 108. In this example, the property name match score is sigma normalized. However, in other implementations it may be normalized in a different way or non-normalized.

In Equation 1, Qₘₚᵥ×Iₚᵥ^{τ} is the match property value term, which computes a property value match score between each of the k match property value(s) specified in the MPV query tensor Qₘₚᵥ and each of the m property values contained in the knowledge base 108.

Reference numeral 722 denotes component i, j of the matrix Qₘₚᵥ×Iₚᵥ^{τ}, which contains the property value match score between the ith query condition and the jth knowledge base property. The property value match score is given by the vector dot product between the embedding vector representing the ith match property value, [mpv_i] (contained in the ith row of Qₘₚᵥ), and the embedding vector representing the jth knowledge base property value, [pv_j] (contained in the jth column of Iₚᵥ^{τ}).

A match between ith query name-value pair ((Qₘₚₙ)ᵢ, (Qₘₚᵥ)ᵢ) and the jth KB name-value pair ((Iₚₙ)ⱼ, (Iₚᵥ)ⱼ) occurs when there is both a relatively high property name match score between (Qₘₚₙ)ᵢ and (Iₚₙ)ⱼ and a relatively high property value match score between (Qₘₚᵥ)ᵢ and (Iₚᵥ)ⱼ.

The Hadamard product Ω(Qₘₚₙ×Iₚₙ^{τ})⊙(Qₘₚᵥ×Iₚᵥ^{τ}) provides a property match score between each of the k query name-value pairs and each of the m KB name-value pairs, accounting for both the extent of name matching and the extent of value matching: component i,j of Ω(Qₘₚₙ×Iₚₙ^{τ})⊙(Qₘₚᵥ×Iₚᵥ^{τ}) is the property match score between the ith query condition and the jth KBP, equal to the product of the property name match score and property value match score between the ith query condition and the jth KBP. For each of the k query conditions, there are m property match scores in total across the knowledge base 108, contained in the ith row of Ω(Qₘₚₙ×Iₚₙ^{τ})⊙(Qₘₚᵥ×Iₚᵥ^{τ}).

The match property importance tensor Qₘₚᵢ contains k numerical values (in k one-dimensional rows), and the ith value of Qₘₚᵢ is a relative importance value assigned to the ith query name-value pair, which in turn weights the m match property scores by relative importance for each i.

In the matching term 702, matrix multiplication by the transpose of KB entity-property mapping tensor, Iₑₚ^{τ} transforms the (weighted)property match scores into entity match scores.

The matching term 702 defines a 1×n dimensioned matrix 730, where component i is the entity match score between the ith entity of the knowledge base 108 and all k query conditions (weighted by relative importance). The matching term 702 is softmax-normalized in this example. Therefore, each match entity score may be interpreted as a probability that the ith query name-value pair matches the jth KB entity. In other implementations, it may be differently normalized or non-normalized.

In Equation 1, the extraction term, denoted by reference sign 704, is (Iₑₚ×(Ω(Iₚₙ×Qₜₚₙ^{τ})⊙Iₚᵥ)). The TPN tensor Qₜₚₙ specifies a target property name, and the extraction term 704 extracts a corresponding target property value for each entity. With the present soft-matching approach, an aggregate target property value is computed for each query name-value pair that is weighted by matching probability. Here, Iₚₙ×Qₜₚₙ^{τ} provides a property name match score between the target property name (specified as a d-dimensional embedding vector in the target property name query tensor Qₜₚₙ) and each of the m property names in the knowledge base 108.

When useful to distinguish, match scores relating to the query conditions (e.g., defined in Qₘₚₙ, Qₘₚᵥ and Qₘₚᵢ) may be referred to as ‘condition’ match scores, and match scores relating to a target property (e.g., defined in Qₜₚₙ) may be referred to as ‘target’ match scores.

The matrix Iₚₙ×Qₜₚₙ^{τ} has dimensions m×1, and is also sigma-normalized; therefore, the pth component of Ω(Iₚₙ×Qₜₚₙ^{τ}), denoted by reference sign 724, can be interpreted as a probability that the target property name matches the pth property contained in the knowledge base 108. In other implementations, this matrix may be differently normalized or non-normalized. More generally, the ith component of Iₚₙ×Qₜₚₙ^{τ} is the target property name match score against the ith KBP. The Hadamard product with the KB property value tensor Iₚᵥ weights every property value in the knowledge base by the
corresponding target property name score. Reference sign 726 denotes the pth KB property value embedding vector, which is the pth row of Iₚᵥ. To compute the Hadamard product, every number in that pth row is multiplied by the pth target property name match score, thereby weighting the property value embedding of the pth KBP with the target property name match score computed against the property name embedding of that pth KBP.

Matrix multiplication of Iₑₚ with (Ω(Iₚₙ×Qₜₚₙ^{τ})⊙Iₚᵥ) returns a n×d matrix 732, which contains a weighted target property value of each of the n entities in the knowledge base 108, weighted by corresponding target property name score(s) (for the property or properties mapped to the entity in question). The extraction term 704 has dimensions n×d, and the ith row is the weighted target property value (d-dimensional embedding) for KB entity i.

Finally, the matrix multiplication between the matching term 702 and the extraction term 704 yields a 1×d dimensional aggregated output value, Oₚᵥ, which is an example of target property value (in this case, aggregated over all n KB entities in this case, weighted by match property score).

As will be appreciated, this is merely one example of an attention function defined over the KB 108. Other attention functions are within the scope for this disclosure. For example, the above aggregation function involves various stages of score-weighted aggregation over properties or entities in the KB 108. In other implementations, alternative forms of aggregations could be used, e.g., ‘max’ aggregation (e.g., by selecting an entity or property with highest relevant score).

Note, the explanation above is provided for illustrative purposes, and does not necessarily imply a particular ordering of the steps. For example, as matrix multiplication is associative, the matrix multiplications of Equation 1 can be performed in any order.

It is important to note that the structured query described above is generated by the neural network 100 itself (e.g., the vision model 100A, the language model 100B or the audio model 100C) as part of this structured attention mechanism which is learnt during model training.

The attention function of Equation 1 does not consider inter-entity relationships. To incorporate such relationships, an additional target entity-entity relationship (tee) tensor, Q_{tec}, is introduced as follows:

[symbol]

Qₘₚᵢ∈ [symbol] ^{1×k},Qₘₚₙ∈ [symbol] ^{k×d},Qₘₚᵥ∈ [symbol] ^{k×d},Qₜₚₙ∈ [symbol] ^{1×d}

[symbol]

Consider the example of the following SQL query: SELECT parent.size WHERE size==“small” AND species==“bear”. Here, a target entity-entity (tee) relationship tensor Q_{tec} is the embedding vector for the relationship “parent”.

$${Q}_{mpi} = [ 1 , 1 ] , {Q}_{mpn} = [ {E}_{size} , {E}_{species} ] , \text{} {Q}_{mpv} = [ {E}_{small} , {E}_{bear} ] , {Q}_{tee} = {E}_{parent} , {Q}_{tpn} = {E}_{size}$$

The updated attention function is defined as follows (Equation 2):

$${O}_{pv} = Φ ( {Q}_{mpi} \times ( Ω ( {Q}_{mpn} \times {I}_{pn}^{T} ) ⊙ ( {Q}_{mpv} \times {I}_{pv}^{T} ) ) \times {I}_{ep}^{T} \times Ω ( {I}_{ee} \times {Q}_{tee} ) ) \times ( {I}_{ep} \times ( Ω ( {I}_{pn} \times {Q}_{tpn}^{T} ) ⊙ {I}_{pv} ) )$$

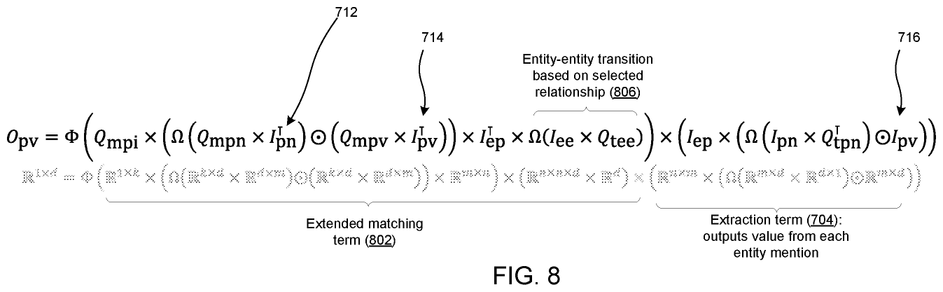

FIG. 8 shows an annotated version of Equation 2, in which an entity-entity transition term is denoted by reference sign 806. A modified match term 802 corresponds to the matching term 702 of Equation 1, with the addition of the entity-entity transition term.

In short, the updated attention function of Equation 2 allows one “hop” from one entity to another based on inter-entity relationships, allowing the equivalent of the query SELECT parent.color WHERE size==“small” AND species==“bear”, instead of just SELECT color WHERE size==“small” AND species==“bear” to be formulated in terms of mathematical manipulations of the property tensor embeddings.

In this case, the transformation sub-layer 105 is extended to include a fifth trainable query generator W^{Q}^{ₜₑₑ} that generates the tensor Q_{tec}.

The query sub-layer 107 evaluates the attention function on the outputs of the transformation sub-layer 106, resulting in an output tensor Oₚᵥ, which is a vector of size d in this example.

Note that the above mechanism is about attending over a KB. A self-attention mechanism can be implemented by conditioning on each property name-value pair to generate a query. This query could be a structured query of the kind described above (if self-attention is desired) or a vector query (if the aim is to, say, attend over text conditioned on a property). When conditioning on the KB itself, the model is equipped with the ability to distinguish between other property name-value pairs that belong to the same entity vs. other entities.

Referring to FIGS. 7 and 8, components 712 and 714 of Equations 1 and 2 (that is, Iₚₙ^{τ} and Iₚᵥ^{τ} in the matching term 702 and the extended matching term 804) act in a role somewhat analogous to keys in traditional neural attention. Component 716 (that is, Iₚᵥ in the extraction term 704) is somewhat analogous to a value in traditional neural attention. However, a key difference with respect to traditional neural attention is that, in Equations 1 and 2, attention is performed over the structured knowledge base 108. Here, Iₚᵥ is acting both as key (in the matching term 702 and the extended matching term 802) and value (in the extraction term 804), which would be changed by doing separate key and value projections.

The output of the attention function, Oₚᵥ, is a target property value tensor, which in this example is an aggregated value vector over the matching properties/entities. In the example scenario considered above, an attention probability is first computed over the entities by computing similarity between the conditions stated in the query and the entity properties, and then within entities we compute a probability distribution over properties based on the property name and the target property name mentioned in the structured query. So, unlike traditional attention that attends over a sequence of items, the network 100 attends over a sequence of entities and pulls out a specific property of the entities (as an aggregate) from the KB 108.

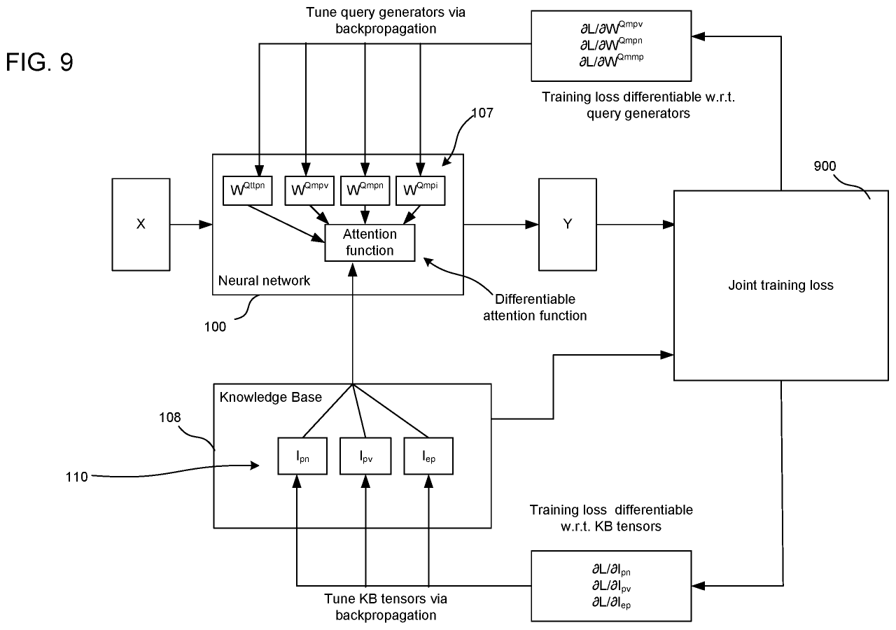

FIG. 9 schematically depicts a joint training regime for the neural network 100 and the KB 108 based on a (single) joint loss function 900.

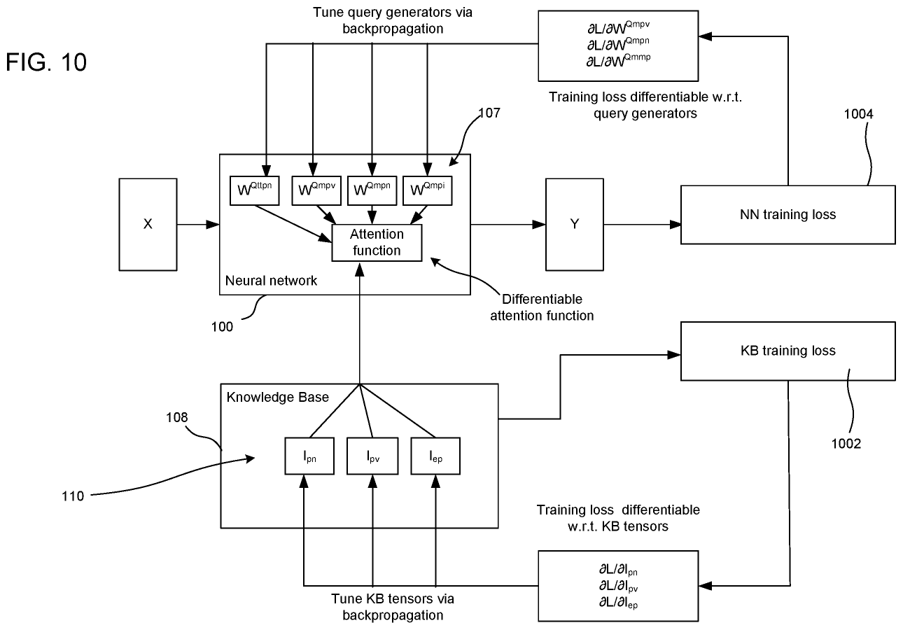

FIG. 10 schematically depicts separate training regimes for the neural network 100 and the KB 108 based on a NN training loss 1004 and a separate KB training loss 1002.

Either approach may be used, or joint and separate training schemes may be combined, to partly train the NN 100 and KB 108 on separate loss functions 1004, 1002, with additional joint training on the joint loss function 900.

As discussed above, the query generators W^{Q}^{ₘₚᵥ}, W^{Q}^{ₘₚₙ}, W^{Q}^{ₘₚᵢ}, W^{Q}^{ₜₚₙ} (and W^{Q}^{ₜₑₑ} if used) are tunable parameters of the neural network. The query tensors are generated through linear matrix (or, more generally, tensor) multiplication with those generators, and the attention function is differentiable. A training loss function (e.g., the joint loss function 900 or the KB training loss 1002) may therefore be defined, which is differentiable with respect to the query generators. It is therefore possible to learn the query generators W^{Q}^{ₘₚᵥ} W^{Q}^{ₘₚₙ}, W^{Q}^{ₘₚᵢ}, W^{Q}^{ₜₚₙ} through gradient-based training, such as backpropagation based on the training loss with gradient descent or ascent.

The KB tensors Iₚₙ∈ [symbol] ^{m×d}, Iₚᵥ∈ [symbol] ^{m×d} and Iₑₚ∈{0,1}^{n×m} (and Iₑₑ if used) are tunable parameters of the KB 108, and admit gradient-based tuning in a similar manner. A training loss can be similarly defined, which is differentiable with respect to the KB tensors, allowing gradient-based updates of those tensors (that is, gradient-based updates of the entity name embeddings, value embeddings, entity-property mappings and, where used, the entity-entity relationships). Note, these gradient-based updates preserve the interpretable structure of the KB 108. The KB tensors may be thought of as the equivalent of the embedding vectors for a text sequence which is input to a traditional attention model. But instead of a single embedding vector, these tensors instead capture the KB structure.

In the joint training of FIG. 9, the single joint training loss 900 may be defined on the output of the neural network 100 and/or an output of the KB 108, and both the query generators of the neural network 100 and the KB tensors of the KB 108 may be used using a gradient-based method on the same training loss.

Alternatively or additionally, in the separate training of FIG. 10, the neural network 100 and the KB 108 may be separately trained on separate training losses.

The ability to use gradient-based training (whether joint or separate) for both the neural network 100 and the knowledge base 108 is motivated by advances in deep learning, and in particular by the ability to implement gradient-based training methods over large training sets on specialized hardware, such as a graphical processing unit(s) (GPU(s)) and/or other accelerator processor(s) (e.g., having a parallel processing architecture). Such processors are able to implement gradient-based updates highly efficiently, typically through parallelization, such as single-instruction multiple-data (SIMD) processing.

A component of a query generator tensor (e.g. W^{Q}^{ₘₚᵥ}, W^{Q}^{ₘₚₙ}, W^{Q}^{ₘₚᵢ}, W^{Q}^{ₜₚₙ} or W^{Q}^{ₜₑₑ}) is one example for a query generator parameter. As noted, whilst the above considers queries generated through matrix multiplication, any parametrized function conducive to gradient-based training may be used.

A component of a KB tensor (e.g., a component of Iₚₖ, Iₚᵥ, Iₑₚ or Iₑₑ) is one example of a knowledge base parameter.

The KB tensors may be implemented as an ‘intermediate’ embedding layer Iₚₖ, IₚᵥIₑₚ or Iₑₑ, on top of a more ‘human-friendly’ knowledge base (e.g., using human-readable strings to represent keys and properties). In this case, a mapping is maintained between the embedding and the more human-friendly representations, so that updates to one are propagated to the other, and vice versa.

An important application of knowledge base training would be to complete or improve an existing partial knowledge base (e.g., where only a subset of property names or values are known, and additional names/values can be inferred from, say, text).

Once trained, errors in the knowledge base can be readily identified and corrected by modifying the relevant part(s) of any of the knowledge base tensors. This is possible, because the additional knowledge learned in training is interpretable from the structure of the knowledge base.

With a second neural model sharing the same knowledge base 108, a second tensor input to a second attention layer of the second neural network would be processing in the same manner, but based on a second query parameter(s) learned in the second neural network.

A ‘stack’ of structured KB attention layers can be used where appropriate. Similar to Transformers that both consume and output a bag of token embeddings (with position encodings), the structured KB attention architecture both consumes and outputs in a similar format that combines token embeddings, property name embeddings, and property value embeddings. This allows us to build deep models with stacked structured KB attention layers with multiple heads.

The mechanisms described above give the ability to implement both: (i) a self-attention mechanism over KB entities, and (ii) a cross-attention mechanism between text and KB entities. Tasks where these architectures may be useful are described.

In some cases, during training, representations of properties (names/values) are learned as the knowledge base tensors 110 are tuned during training. For example, embeddings of existing properties may be learned. Once trained, the embeddings may be fixed, but e.g., new property values can be written to the trained KB 108. For example, when trained on a joined masked modeling task described below, the neural network 100 may be capable of both reading values from the KB 108 and writing values to the KB 108.

Note, the training does not necessarily involve learning property name/values for any specific KB during training. Rather, relationships between properties may be learned during training (captured in the learned property embeddings), enabling, for example, subsequent predictions missing properties etc.

Note that the dimensions m, n of the knowledge base 108 are not fixed after training. Entities and/or property value pairs can be added or removed, which may consequently change the value of m and/or n. This does not require any modification to the attention function described above. For example, an additional name-property value pair could be added to the KB 108 (e.g., whose embeddings are derived from some other part or parts of the knowledge base and/or from some other input such as text, image etc.), and an additional row may be added to the entity-property mapping tensor Iₑₚ to map the new property-name value pair to an existing entity (keeping n fixed) or a new entity (which becomes entity n+1 in the knowledge base).

A write mechanism may, for example, be implemented by implementing the neural network 100 with a third attention function over some input data (e.g., image, text, audio, cybersecurity data etc. inputted to the neural network 100) that returns a structured piece of knowledge extracted from the input data (e.g., a name embedding vector and a value embedding vector representing an extracted key-value pair), which in turn can be added to the knowledge base 108.

### Joint Text and KB Masked Modeling

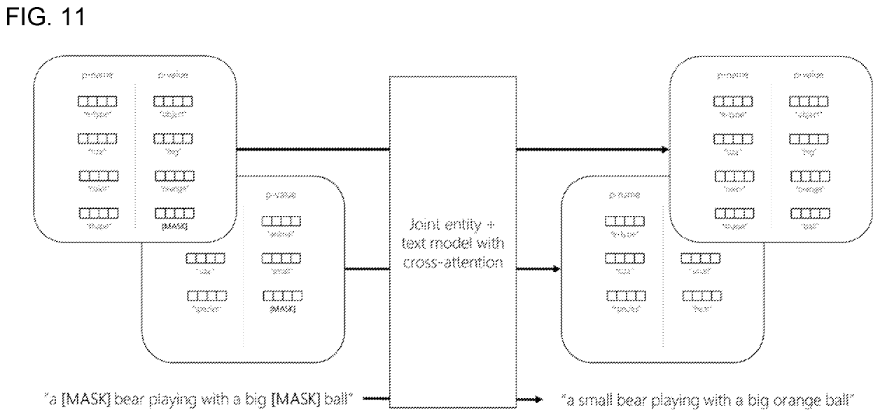

FIG. 11 schematically depicts an example of a joint text and knowledge base masked modeling task.

Other masked modeling formulations can be defined jointly over text and KB such that the system can simultaneously attend to both the KB and the text to predict missing text tokens, property names, and property values.

The input to the model in this case is a text extract and a sample of the KB, such that similar entities and properties are mentioned in both. A straightforward method to generate such pairs would be to sample entities and properties from a KB and then retrieve relevant extracts from a text collection.

The joint mask modeling of text and KB has some interesting properties in that it presents a unified view over several underlying tasks of interests. In traditional masked modeling over text, p % of tokens may be masked that the model needs to predict. When mask modeling KB and text jointly, pₜₑₓₜ% of tokens may be masked in the text and p_{kb}% of KB properties may be masked at the same time. When pₜₑₓₜ=⁰ and p_{kb}=100, the task reduces to information extraction—i.e., given text, extract structured information in the text. Conversely, when pₜₑₓₜ=100 and p_{kb}=0, the task is similar to text generation conditioned on a KB. Furthermore, when pₜₑₓₜ=100 and p_{kb}<100, then the task becomes KB completion. Training on the joint masked modeling task may achieve more robust performance on each of these tasks.

### Connection to Diffusion

A special class of generative models, called diffusion, have recently achieved remarkable results in image and other content generation. Masked modeling of text can be viewed as a single step in a text diffusion process—in the forward diffusion process each time step t is associated with a different probability pₜ of token masking and pₜ₊₁>pₜ strictly for all values of t. Analogously, in our joint text and KB mask modeling scenario we have two different probabilities of masking—pₜₑₓₜ and p_{kb}. This approach may be extended to a diffusion like setup by considering two different “temporal” dimensions, one for text and one for KB—so, a given step is defined by pₜ_{ₜₑₓₜ} and pₜ_{_{kb}}. As before, these two variables define a spectrum over several interesting machine learning tasks.

### Entity Linking

Another useful task where structured attention over KB entities may be useful is in entity linking. The task here is to predict, given two entity fragments, whether they correspond to the same entity. Using the structured attention mechanism described above, two entity fragments may be inputted to the system. Based on the embedding representation of the relationship between the two entities, the system is trained to predict whether they are the same entity or not. Such a task can benefit from a powerful model of entity property correlations. Such a model could be pretrained on a KB completion task before being finetuned for the entity linking task.

In summary, the described ML architecture provides a foundation model for knowledge. An explicit model for structured knowledge may have additional implications with respect to interpretability and potential for manual interventions in the context of other existing foundation models. It can help us to go beyond current approaches where knowledge about the world is stored in the parameters of the foundation models (e.g., LLMs) in forms that are not human-interpretable, verifiable, or correctable. Implicit knowledge in large language models may be distilled into human-interpretable symbolic representation and provide mechanisms for human intervention in correcting errors in the inferred knowledge.

Multimodal deep learning systems can be implemented that comprise models of language, vision, and audio that jointly attend to an explicit model of knowledge as a central and binding component.

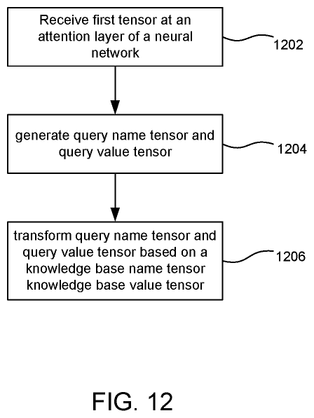

FIG. 12 shows a flowchart for a neural network attention method.

At step 1202, a first tensor (or tensors) is received at an attention layer of a neural network. The first tensor(s) may, for example, comprise the input tensor 105 of FIG. 6.

At step 1204, based on the first tensor(s) and at least one query generator parameter of the attention layer (e.g., the query generators 109) a query name tensor (e.g., Qₘₚₙ) and a query value tensor (e.g., Qₘₚᵥ) are generated.

At step 1206, the query name tensor and query value tensor are transformed based on a knowledge base name tensor (e.g., Iₚₙ) and a query value tensor (e.g., Iₚᵥ) resulting in an aggregate output value. The knowledge base name tensor comprises numerical name vectors representing property names of a knowledge base (e.g., the knowledge base 100). The knowledge base value tensor represents property values associated with the property names in the knowledge database.

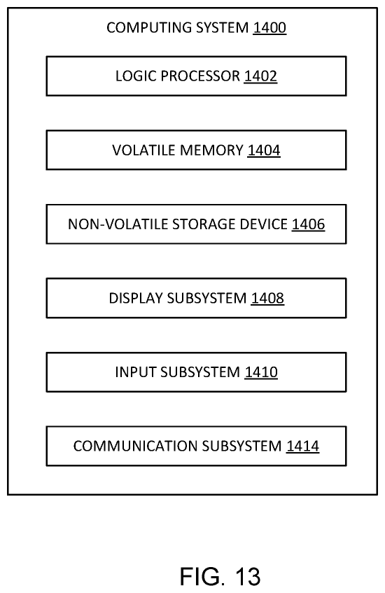

FIG. 13 schematically shows a non-limiting example of a computing system 1400, such as a computing device or system of connected computing devices, that can enact one or more of the methods or processes described above. Computing system 1400 is shown in simplified form. Computing system 1400 includes a logic processor 1402, volatile memory 1404, and a non-volatile storage device 1406. Computing system 1400 may optionally include a display subsystem 1408, input subsystem 1410, communication subsystem 1414, and/or other components not shown in FIG. 13. Logic processor 1402 comprises one or more physical (hardware) processors configured to carry out processing operations. For example, the logic processor 1402 may be configured to execute instructions that are part of one or more applications, programs, routines, libraries, objects, components, data structures, or other logical constructs. The logic processor 1402 may include one or more hardware processors configured to execute software instructions based on an instruction set architecture, such as a central processing unit (CPU), graphical processing unit (GPU) or other form of accelerator processor. Additionally or alternatively, the logic processor 1402 may include a hardware processor(s)) in the form of a logic circuit or firmware device configured to execute hardware-implemented logic (programmable or non-programmable) or firmware instructions. Processor(s) of the logic processor 1402 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 1402 may be virtualized and executed by remotely accessible, networked computing devices configured in a cloud-computing configuration. In such a case, these virtualized aspects are run on different physical logic processors of various different machines. Non-volatile storage device 1406 includes one or more physical devices configured to hold instructions executable by the logic processor 1402 to implement the methods and processes described herein. When such methods and processes are implemented, the state of non-volatile storage device 1406 may be transformed—e.g., to hold different data. Non-volatile storage device 1406 may include physical devices that are removable and/or built-in. Non-volatile storage device 1406 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 1406 may include nonvolatile, dynamic, static, read/write, read-only, sequential-access, location-addressable, file-addressable, and/or content-addressable devices. Volatile memory 1404 may include one or more physical devices that include random access memory. Volatile memory 1404 is typically utilized by logic processor 1402 to temporarily store information during processing of software instructions. Aspects of logic processor 1402, volatile memory 1404, and non-volatile storage device 1406 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 1400 typically implemented in software by a processor to perform a particular function using portions of volatile memory, which function involves transformative processing that specially configures the processor to perform the function. Thus, a module, program, or engine may be instantiated via logic processor 1402 executing instructions held by non-volatile storage device 1406, using portions of volatile memory 1404. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 1408 may be used to present a visual representation of data held by non-volatile storage device 1406. The visual representation may take the form of a graphical user interface (GUI). As the herein described methods and processes change the data held by the non-volatile storage device, and thus transform the state of the non-volatile storage device, the state of display subsystem 1408 may likewise be transformed to visually represent changes in the underlying data. Display subsystem 1408 may include one or more display devices utilizing virtually any type of technology. Such display devices may be combined with logic processor 1402, volatile memory 1404, and/or non-volatile storage device 1406 in a shared enclosure, or such display devices may be peripheral display devices. When included, input subsystem 1410 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 1414 may be configured to communicatively couple various computing devices described herein with each other, and with other devices. Communication subsystem 1414 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1400 to send and/or receive messages to and/or from other devices via a network such as the internet. The term computer readable media as used herein may include computer storage media. Computer storage media may include volatile and non-volatile, removable and nonremovable media (e.g., volatile memory 1404 or non-volatile storage 1406) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 1400 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

According to a first aspect disclosed herein, a computer-implemented method comprises: receiving at an attention layer of a neural network at least one first tensor; generating, based on the at least one first tensor and at least one query generator parameter of the attention layer, a structured query comprising: a target property name embedding vector, a match property name embedding vector, and a match property value embedding vector associated with the match property name embedding vector; computing a condition property name match score between the match property name embedding vector of the structured query and a first property name embedding vector, the first property name embedding vector numerically representing a first property name of a first property name-value pair of a structured knowledge base; computing a condition property value match score between the match property value embedding vector of the structured query and a first property value embedding vector, the first property value embedding vector numerically representing a first property value of the first name-value pair of the structured knowledge base; and based on the condition property name match score, the condition property value match score, a second property name-value pair of the structured knowledge base, and the target property name embedding vector, calculating a target property value embedding vector numerically representing a target property value.

In embodiments, the structured knowledge base may comprise an entity-property mapping tensor numerically encoding a first entity-property mapping relating to the first property name-value pair, and a second entity-property mapping relating to the second property name-value pair. The target property value embedding vector may be calculated based on the entity-property mapping tensor.

The structured knowledge base may comprise a knowledge base entity-entity relationship tensor numerically encoding relationships between entities. The structured query may comprise a target entity-entity relationship tensor, and the target property value embedding vector may be calculated based on the knowledge base entity-entity relationship tensor and the target entity-entity relationship tensor.

The structured query may comprise a target property name embedding vector. The method may comprise computing a target property name match score between a target property name embedding vector and a second property name embedding vector that numerically represents a second property name of the second property name-value pair. The target property value embedding vector may be calculated based on: the target property name match score, and a second property value embedding vector that numerically represents a second property value of the second property name-value pair.

The target property value embedding vector may be calculated based on: a product of the condition property name match score with the condition property value match score, and the second property value embedding vector weighted by the target property name match score.

The structured knowledge base may comprise an entity-property mapping tensor numerically encoding a first entity-property mapping relating to the first property name-value pair, and a second entity-property mapping relating to the second property name-value pair. The target property value embedding vector may be calculated based on the entity-property mapping tensor.

The structured knowledge base may comprise a plurality of property name-value pairs, each property name-value pair comprising: a property name embedding vector numerically representing a property name, and a property value embedding vector numerically representing a property value associated with the property name, the structured query comprising, the plurality of name-value pairs comprising the first name-value pair and the second name-value pair. The target property value embedding vector may be calculated based on: a target property name match score computed between the target property name embedding vector of the structured query and the property name embedding vector of each property name-value pair of the structured knowledge base, and the property value embedding vector of each property name-value pair of the structured knowledge base.

The structured knowledge base may comprise a plurality of property name-value pairs, where each property name-value pair may comprise: a property name embedding vector numerically representing a property name, and a property value embedding vector numerically representing a property value associated with the property name. The plurality of name-value pairs may comprise the first name-value pair and the second name-value pair. The target property value embedding vector may be calculated based on: a condition property name match score computed between the match property name embedding vector of the structured query and the property name embedding vectors of each property name-value pair of the structured knowledge base, a condition property value match score computed between the match property value embedding vector of the structured query and the property value of each property name-value pair of the structured knowledge base, and an entity-property mapping tensor numerically encoding an entity-property mapping for each property name-value pair of the knowledge database.

The method may comprise computing on a graphical processing unit or other accelerator processor a gradient of a training loss function with respect to the at least one query generator parameter; and updating the at least one query generator parameter based on the gradient of the training loss function.

The method may comprise computing on a graphical processing unit or other accelerator processor a first gradient of a joint training loss function with respect to the at least one query generator parameter; updating the at least one query generator parameter based on the first gradient; computing a second gradient of the joint training loss function with respect to a knowledge base parameter of the structured knowledge base; and updating, based on the second gradient of the joint training loss function, the knowledge base parameter.

The knowledge base parameter may, for example, comprise a component of a property name embedding vector of the structured knowledge base or a component of a property value embedding vector of the structured knowledge base.

The training loss function may encode a joint masked modeling task.

The method may comprise generating an output using the using the neural network applied to an input comprising at least one of: image data, video data, audio data, text data, cybersecurity data, sensor data, medical data.

The at least one first tensor may embody cybersecurity telemetry, and the method may comprise: generating, based on the target property name embedding vector, a detection output; and performing a cybersecurity action based on the detection output.

The structured query may comprise a second match property name embedding vector, a second match property value embedding vector associated with the second match property name embedding vector, and a match property importance tensor that weights the match property name embedding vector and the match property value embedding vector relative to the second match property name embedding vector and the second match property value embedding vector.

According to a second aspect herein, a computer system comprises: at least one memory configured to store: executable instructions, and a structured knowledge base comprising: property name-value pairs, each property name-value pair comprising: a property name embedding vector numerically representing a property name, and a property value embedding vector numerically representing a property value associated with the property name, and an entity-property mapping tensor numerically encoding an entity-property mapping for each property name-value pair; and at least one processor coupled to the at least one memory, and configured to execute the executable instructions, which upon execution cause the at least one processor to perform at least one of a read operation on the knowledge base and a write operation on the knowledge base.

The read operation may comprise extracting from the knowledge base, based on the entity-property mapping tensor: a target property name embedding vector, or a target property value embedding vector.

The write operation may comprise at least one of modifying the entity-property mapping tensor, modifying a property name embedding vector contained in the knowledge base, modifying a property value embedding vector contained in the knowledge base, generating a further property name embedding vector in the knowledge base, and generating a further property value embedding vector in the knowledge base.

The executable instructions may be configured to cause the at least one processor to perform the read operation, where the read operation may comprise calculating a target property value embedding vector based on: the entity-property mapping tensor, a condition property name match score computed between a match property name embedding vector and each property name embedding vector the structured knowledge base, and a condition property value match score computed between a match property value embedding vector.

The executable instructions may be configured to cause the at least one processor to perform the read operation, where the read operation may comprise calculating a target property value embedding vector based on: the entity-property mapping tensor, a condition property name match score computed between a match property name embedding vector and each property name embedding vector the structured knowledge base, and a condition property value match score computed between a match property value embedding vector.

The target property value embedding vector may, in addition, be based on each property value embedding vector of the structured knowledge base.

The executable instructions may be configured to cause the at least one processor to perform the write operation, where the write operation may comprise modifying a property value embedding vector of the structured knowledge base.

The executable instructions may be configured to cause the at least one processor to: compute a gradient of a training loss function with respect to a knowledge base parameter of the structured knowledge base; and update the knowledge base parameter based on the gradient of the training loss function.

The knowledge base parameter may, for example, comprise a component of a property name embedding vector of the structured knowledge base or a component of a property value embedding vector of the structured knowledge base.

The at least one processor may comprise a graphical processing unit or other accelerator processor configured to compute the gradient of the training loss function.

The training loss function may encode an entity linking task.

The structured knowledge base may additionally comprise a human-interpretable representation of each property name-value pair.

According to a third aspect herein, a computer-readable storage medium is configured to store executable instructions, which are configured to, upon execution by at least one processor, cause the at least one processor to implement operations comprising: receiving a structured query comprising: a match property name embedding vector, a match property value embedding vector associated with the match property name embedding vector, and a target property name embedding vector numerically representing a target property name; computing a condition property name match score between the match property name embedding vector of the structured query and a first property name embedding vector, the first property name embedding vector numerically representing a first property name of a first property name-value pair of a structured knowledge base; computing a condition property value match score between the match property value embedding vector of the structured query and a first property value embedding vector, the first property value embedding vector numerically representing a first property value of the first property name-value pair of the structured knowledge base; and based on the condition property name match score, the condition property value match score, and a second property-name value pair of the structured knowledge base, returning a target property value embedding vector numerically representing a target property value associated with the target property name.

According to a fourth aspect herein, a computer-implemented method comprises: receiving at an attention layer of a neural network at least one first tensor; generating, based on the at least one first tensor and at least one query generator parameter of the attention layer: a query name tensor, and a query value tensor; and transforming the query name tensor and the query value tensor based on a knowledge base key tensor comprising a plurality of numerical name vectors representing property names of a knowledge base and a knowledge base name tensor containing a plurality of numerical value vectors representing property values associated with the property names in the knowledge database, resulting in an aggregated value vector.

The query name tensor and the query value tensor may be transformed based on the knowledge base key tensor, the knowledge base value tensor and a knowledge base mapping tensor comprising numerical values representing mappings between a plurality of entities and the property names and the associated property values.

Transforming the query name tensor and the query value tensor may comprise calculating an attention function comprising: a first term reflecting a first probability distribution of the property names, and a second term reflecting an aggregate of a target property value over the plurality of entities weighted by the first probability distribution.

A query entity relationship tensor may be generated based on the at least one first tensor and the at least one query generator parameter, wherein the query name tensor, the query value tensor and the query entity relationship tensor are transformed based on the knowledge base key tensor, the knowledge base value tensor and a knowledge base relationship tensor comprising numerical values representing between the entities.

Transforming the query name tensor and the query value tensor may comprise calculating an attention function comprising a third term reflecting a target entity-entity relationship.

The method may comprise computing a gradient of a training loss function with respect to the at least one query generator parameter; and updating the at least one query generator parameter based on the gradient.

The method may comprise computing a first gradient of a training loss function with respect to the at least one query generator parameter; updating the at least one query generator parameter based on the first gradient; computing a second gradient of the training loss function with respect to a knowledge base parameter of the knowledge base key tensor or the knowledge base value tensor; and updating the at least one knowledge parameter based on the gradient.

The training loss function may encode a joint masked modeling task.

The method may comprise computing a gradient of a training loss function with respect to a knowledge base parameter of the knowledge base key tensor or the knowledge base value tensor; and updating the at least one knowledge parameter based on the gradient.

The training loss function may encode an entity linking task.

A query entity relationship tensor may be generated based on the at least one first tensor and the at least one query generator parameter, wherein the query name tensor, the query value tensor and the query entity relationship tensor may be transformed based on the knowledge base key tensor, the knowledge base value tensor and a knowledge base relationship tensor comprising numerical values representing between the entities.

The neural network may be a text-modality neural network, a vision-modality neural network or an audio-modality neural network.

The method may comprise receiving at a second attention layer of a second neural network at least one second tensor; generating, based on the at least one second tensor and at least one second query generator parameter of the second attention layer: a second query name tensor, and a second query value tensor; and transforming the second query name tensor and the second query value tensor based on the knowledge base key tensor and the knowledge base name tensor.

The first neural network may have a first modality and the second neural network may have a second modality different from the first modality.

The (first and/or second) gradient may be computed on a graphical processing unit or other accelerator processor.

A further aspect herein provides a computer system comprising at least one memory storing executable instructions, and at least one processor coupled to the at least one memory, and configured to execute the executable instructions, which upon execution cause the at least one processor to implement any functionality disclosed herein.

A further aspect herein provides a computer-readable storage medium configured to store executable instructions, which are configured to, upon execution by at least one processor, cause the at least one processor to implement any functionality disclosed herein.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the present disclosure.

1. A computer-implemented method comprising:
receiving at an attention layer of a neural network at least one first tensor;
generating, based on the at least one first tensor and at least one query generator parameter of the attention layer, a structured query comprising: a target property name embedding vector, a match property name embedding vector, and a match property value embedding vector associated with the match property name embedding vector;
computing a condition property name match score between the match property name embedding vector of the structured query and a first property name embedding vector, the first property name embedding vector numerically representing a first property name of a first property name-value pair of a structured knowledge base;
computing a condition property value match score between the match property value embedding vector of the structured query and a first property value embedding vector, the first property value embedding vector numerically representing a first property value of the first name-value pair of the structured knowledge base; and
based on the condition property name match score, the condition property value match score, a second property name-value pair of the structured knowledge base, and the target property name embedding vector, calculating a target property value embedding vector numerically representing a target property value.

2. The computer-implemented method of claim 1, wherein the structured knowledge base comprises an entity-property mapping tensor numerically encoding a first entity-property mapping relating to the first property name-value pair, and a second entity-property mapping relating to the second property name-value pair;
wherein the target property value embedding vector is calculated based on the entity-property mapping tensor.

3. The computer-implemented method of claim 2, wherein the structured knowledge base comprises a knowledge base entity-entity relationship tensor numerically encoding relationships between entities, wherein the structured query comprises a target entity-entity relationship tensor, and wherein the target property value embedding vector is calculated based on the knowledge base entity-entity relationship tensor and the target entity-entity relationship tensor.

4. The computer-implemented method of claim 1, comprising:
computing a target property name match score between the target property name embedding vector and a second property name embedding vector that numerically represents a second property name of the second property name-value pair;
wherein the target property value embedding vector is calculated based on: the target property name match score, and a second property value embedding vector that numerically represents a second property value of the second property name-value pair.

5. The computer-implemented method of claim 4, wherein the target property value embedding vector is calculated based on:
a product of the condition property name match score with the condition property value match score, and
the second property value embedding vector weighted by the target property name match score.

6. The computer implemented method of claim 4, wherein the structured knowledge base comprises an entity-property mapping tensor numerically encoding a first entity-property mapping relating to the first property name-value pair, and a second entity-property mapping relating to the second property name-value pair;
wherein the target property value embedding vector is calculated based on the entity-property mapping tensor.

7. The computer-implemented method of claim 4, wherein the structured knowledge base comprises a plurality of property name-value pairs, each property name-value pair comprising: a property name embedding vector numerically representing a property name, and a property value embedding vector numerically representing a property value associated with the property name, the plurality of name-value pairs comprising the first name-value pair and the second name-value pair;
wherein the target property value embedding vector is calculated based on:
a target property name match score computed between the target property name embedding vector of the structured query and the property name embedding vector of each property name-value pair of the structured knowledge base

8. The computer-implemented method of claim 7, wherein the target property value embedding vector is calculated based on the property value embedding vector of each property name-value pair of the structured knowledge base.

9. The computer-implemented method of claim 1, wherein the structured knowledge base comprises a plurality of property name-value pairs, each property name-value pair comprising: a property name embedding vector numerically representing a property name, and a property value embedding vector numerically representing a property value associated with the property name, the plurality of name-value pairs comprising the first name-value pair and the second name-value pair;
wherein the target property value embedding vector is calculated based on:
a condition property name match score computed between the match property name embedding vector of the structured query and the property name embedding vectors of each property name-value pair of the structured knowledge base,
a condition property value match score computed between the match property value embedding vector of the structured query and the property value of each property name-value pair of the structured knowledge base, and
an entity-property mapping tensor numerically encoding an entity-property mapping for each property name-value pair of the knowledge database.

10. The computer-implemented method of claim 1, comprising:
computing on a graphical processing unit or other accelerator processor a gradient of a training loss function with respect to the at least one query generator parameter; and
updating the at least one query generator parameter based on the gradient of the training loss function.

11. The computer-implemented method of claim 1, comprising:
computing on a graphical processing unit or other accelerator processor a first gradient of a joint training loss function with respect to the at least one query generator parameter;
updating the at least one query generator parameter based on the first gradient;
computing a second gradient of the joint training loss function with respect to a knowledge base parameter of the structured knowledge base; and
updating, based on the second gradient of the joint training loss function, the knowledge base parameter.

12. The computer implemented method of claim 11, wherein the training loss function encodes a joint masked modeling task.

13. The computer implemented method of claim 1, comprising:
generating an output using the neural network applied to an input comprising at least one of: image data, video data, audio data, text data, cybersecurity data, sensor data, medical data.

14. The computer-implemented method of claim 1, wherein the at least one first tensor embodies cybersecurity telemetry, the method comprising:
generating, based on the target property name embedding vector, a detection output; and
performing a cybersecurity action based on the detection output.

15. A computer system comprising:
at least one memory configured to store:
executable instructions, and
a structured knowledge base comprising:
property name-value pairs, each property name-value pair comprising: a property name embedding vector numerically representing a property name, and a property value embedding vector numerically representing a property value associated with the property name, and
an entity-property mapping tensor numerically encoding an entity-property mapping for each property name-value pair; and
at least one processor coupled to the at least one memory, and configured to execute the executable instructions, which upon execution cause the at least one processor to perform at least one of:
a read operation comprising extracting from the knowledge base, based on the entity-property mapping tensor: a target property name embedding vector, or a target property value embedding vector, and
a write operation comprising at least one of:
modifying the entity-property mapping tensor,
modifying a property name embedding vector contained in the knowledge base,
modifying a property value embedding vector contained in the knowledge base,
generating a further property name embedding vector in the knowledge base, and
generating a further property value embedding vector in the knowledge base.

16. The computer system of claim 15, wherein the executable instructions are configured to cause the at least one processor to:
compute a gradient of a training loss function with respect to a knowledge base parameter of the structured knowledge base; and
update the knowledge base parameter based on the gradient of the training loss function.

17. The computer system of claim 16, wherein the at least one processor comprises a graphical processing unit or other accelerator processor configured to compute the gradient of the training loss function.

18. The computer system of claim 16, wherein the training loss function encodes an entity linking task.

19. The computer system of claim 15, wherein the structured knowledge base additionally comprises a human-interpretable representation of each property name-value pair.

20. A computer-readable storage medium configured to store executable instructions, which are configured to, upon execution by at least one processor, cause the at least one processor to implement operations comprising:
receiving a structured query comprising: a match property name embedding vector, a match property value embedding vector associated with the match property name embedding vector, and a target property name embedding vector numerically representing a target property name;
computing a condition property name match score between the match property name embedding vector of the structured query and a first property name embedding vector, the first property name embedding vector numerically representing a first property name of a first property name-value pair of a structured knowledge base;
computing a condition property value match score between the match property value embedding vector of the structured query and a first property value embedding vector, the first property value embedding vector numerically representing a first property value of the first property name-value pair of the structured knowledge base; and
based on the condition property name match score, the condition property value match score, and a second property-name value pair of the structured knowledge base, returning a target property value embedding vector numerically representing a target property value associated with the target property name.
